(19) United States
(12) Patent Application Publication
(10) Pub. No.: US 2019/0263399 A1
(43) Pub. Date: Aug. 29, 2019

(54) INTELLIGENT VEHICLE SAFETY DRIVING ENVELOPE RECONSTRUCTION METHOD BASED ON INTEGRATED SPATIAL AND DYNAMIC CHARACTERISTICS

(71) Applicant: JIANGSU UNIVERSITY, Zhenjiang (CN)

(72) Inventors: Youguo HE, Zhenjiang (CN); Chaochun YUAN, Zhenjiang (CN); Long CHEN, Zhenjiang (CN); Haobin JIANG, Zhenjiang (CN); Yingfeng CAI, Zhenjiang (CN); Hai WANG, Zhenjiang (CN)

(21) Appl. No.: 16/342,974

(22) PCT Filed: Mar. 29, 2017
(86) PCT No.: PCT/CN2017/078515

§ 371 Date: Apr. 18, 2019

(30) Foreign Application Priority Data
Oct. 19, 2016 (CN) 201610910181.0

(51) Int. Cl. B60W 30/095; B60W 50/00; G05D 1/02; G05D 1/00

(52) U.S. Cl. CPC B60W 30/0956; B60W 50/0097; B60W 50/0098; G05D 1/0214; G05D 2201/0213; B60W 2550/306; B60W 2520/14; B60W 2050/0028; G05D 1/0088

(57) ABSTRACT

Provided is an intelligent vehicle safety driving envelope reconstruction method on the basis of integrated spatial and dynamic characteristics. Starting from simulating an actual driver's estimation of potential collision risks in the forward driving area, a prediction result of a front vehicle driving behavior is introduced to an environment perception link of the intelligent vehicle; on the basis of the prediction result of the front vehicle driving behavior, a safety driving envelope of the intelligent vehicle is reconstructed by integrating spatial and dynamic characteristics (a safety environment envelope reconstruction and a stable control envelope reconstruction), so as to improve the safety and stability of intelligent vehicle. First, based on the prediction of the front vehicle driving behavior, a lateral and a longitudinal distance between the intelligent vehicle and the front vehicle are corrected, to realize the envelop reconstruction of the safety environment of the intelligent vehicle and to improve the safety of intelligent vehicle. Then, on the basis of the reconstructed safety environment envelope and an dynamical model of the intelligent vehicle, the stable control envelope of the intelligent vehicle is reconstructed, so as to improve the stability of the intelligent vehicle.

### TECHNICAL FIELD

The invention relates to the field of intelligent vehicle, in particular to a reconstruction method of intelligent vehicle safety driving envelope combining spatial and dynamic characteristics.

### BACKGROUND TECHNOLOGY

With the rapid development of automobile industry and the continuous improvement of people's living standards, the car ownership continues to climb, followed by a series of urgent problems such as increasing traffic pressure, road congestion, frequent traffic accidents and so on. As an effective way to solve the above problems, intelligent transportation system has attracted wide attention from all walks of life. As a new technology in intelligent transportation system, intelligent vehicle has become a research hotspot at home and abroad. The first problem to be solved in intelligent vehicles is environmental perception, which is to perceive the traffic environment around vehicles and the motion parameters of intelligent vehicles through visual sensors, radar sensors, vehicle sensors and so on. It can be found that domestic and foreign scholars have only perceived the current motion parameters of surrounding vehicles of intelligent vehicle, and carry out path planning and tracking control nowadays. However, the random change of driving behavior of surrounding vehicles, especially forward vehicles, makes it difficult for intelligent vehicles to predict the potential collision risk, thus affecting the accuracy of path planning and tracking control. Therefore, in order to simulate the behavior of predicting potential collision risk during human driving, the forward vehicle driving behavior prediction is introduced into the safety environment envelope. According to the prediction results of forward vehicle driving behavior, the safety driving envelope (safety environment envelope and stable control envelope) is reconstructed by combining spatial and dynamic characteristics, so as to provide a basis for intelligent vehicle planning and decision-making from the perspective of safety and stability.

Therefore, the invention proposes a safty driving envelope reconstruction method for intelligent vehicles that integrates spatial and dynamic characteristics. It senses the traffic environment said forward vehicle of intelligent vehicle through camera and lidar and predicts forward vehicle driving behavior. Based on the prediction results of forward vehicle driving behavior, the lateral and longitudinal spacing between intelligent vehicles and forward vehicles are modified to reconstruct the safely environment envelope of intelligent vehicles. At the same time, according to the reconstructed safety environment envelope, combined with the intelligent vehicle dynamics model, the stability control envelope of the intelligent vehicle is reconstructed, and the potential collision risk in the driving area of the intelligent vehicle is estimated to improve the safety and stability of the intelligent vehicle. By consulting the data, the reconstruction method of safe driving envelope of intelligent vehicle by combining spatial and dynamic characteristics has not been reported yet.

### CONTENTS OF THE INVENTION

The aim of the invention is to provide a reconstruction method of intelligent vehicle safety driving envelope combining spatial and dynamic characteristics. Starting from simulating the real driver's behavior of predicting the potential collision risk in the forward driving area, the prediction of forward driving behavior is introduced into the environmental perception of intelligent vehicles. The safety driving envelope (safely environment envelope and stable control envelope) is reconstructed by combining spatial and dynamic characteristics, so as to improve the safety and stability of intelligent vehicle. Firstly, based on the prediction results of forward vehicle driving behavior, the lateral and longitudinal distances between the intelligent vehicle and the front vehicle are corrected, to realize the envelop reconstruction of the safety environment of the intelligent vehicle and to improve the safety of intelligent vehicle. Then, on the basis of the reconstructed safety environment envelope and a dynamical model of the intelligent vehicle, the stable control envelope of the intelligent vehicle is reconstructed, so as to improve the stability of the intelligent vehicle.

The technical scheme of the invention: A reconstruction method of intelligent vehicle safety driving envelope combining spatial and dynamic characteristics is composed of safety environment envelope reconstruction algorithm and the stable control envelope reconstruction algorithm. Based on the prediction results of forward vehicle driving behavior from the driving behavior prediction model, the safety environment envelope reconstruction algorithm is responsible for modifying the lateral and longitudinal safe distances between the intelligent vehicle and forward vehicle, to realize the pre-estimation to the potential collision risk in the driving area of the intelligent vehicle, and improves the safety of the intelligent vehicle. To improve the stability of the intelligent vehicle, stable control envelope reconstruction algorithm is responsible for the reconstruction of stable region of the yaw rate based on the results of the environment envelope reconstruction and the dynamic characteristics of the intelligent vehicle.

Reconstruction algorithm for safety environment envelope described in the invention is as follows:

The secure diving area in front of the intelligent vehicle is determined based on the lateral and longitudinal distance between the forward vehicle and the intelligent vehicle, that is, the safety environment envelope is described in this invention. According to the sensor and dynamic model, the relative position information of the intelligent vehicle and the forward vehicle is established, as shown in formula (1):

$$[ \begin{matrix}Δ {p}_{x , j} ( t ) \\ Δ {p}_{y , j} ( t )\end{matrix} ] = [ \begin{matrix}cos ( - {e}_{ψ} ( t ) ) & - sin ( - {e}_{ψ} ( t ) ) \\ sin ( - {e}_{ψ} ( t ) ) & cos ( - {e}_{ψ} ( t ) )\end{matrix} ] [ \begin{matrix}{p}_{x , j} ( t ) - {p}_{x , sub} ( t ) \\ {p}_{y , j} ( t ) - {p}_{y , sub} ( t )\end{matrix} ] \qquad ( 1 )$$

Where p_{x,j}(t) is the longitudinal coordinates of the jth forward vehicle; p_{x,sub}(t) is the longitudinal coordinates of the intelligent vehicle; e_{Ψ}(t) is the position error between vehicle and road surface; p_{y,j}(t) is the lateral coordinates of the jth forward vehicle; p_{y,sub}(t) is the lateral coordinates of the intelligent vehicle; Δp_{x,j}(t) is the longitudinal relative distance between the smart vehicle and the jth forward vehicle; Δp_{y,j}(t) is the lateral relative distance between the smart vehicle and the jth forward vehicle.

The distance between intelligent vehicle and forward vehicle can be obtained by transformation, as shown in equation (2):

$$[ \begin{matrix}{C}_{x , j} ( t ) \\ {C}_{y , j} ( t )\end{matrix} ] = [ \begin{matrix}Δ {p}_{x , j} ( t ) \\ Δ {p}_{y , j} ( t )\end{matrix} ] - [ \begin{matrix}sgn ( Δ {p}_{x , j} ( t ) ) \cdot {L}_{v} \\ sgn ( Δ {p}_{y , j} ( t ) ) {W}_{v}\end{matrix} ] \qquad ( 2 )$$

where: Lᵥ is the length of the forward vehicle; Wᵥ is the width of the forward vehicle; C_{x,j}(t) is the longitudinal distance between intelligent vehicle and forward vehicle; C_{y,j}(t) is the lateral distance between intelligent vehicle and forward vehicle.

The longitudinal and lateral distance between the intelligent vehicle and the forward vehicle expressed in equation (2) is calculated based on the current position of the forward vehicle, which is regarded as the reference value of the safety environment envelope of the intelligent vehicle at a given next time, and the randomicity of driving behavior changes of the forward vehicle is not considered. The lateral distance between the intelligent vehicle and forward vehicle will increase or decrease at the next moment, when the forward vehicle has left-turn driving behavior or right-turn driving behavior. The longitudinal distance between the intelligent vehicle and forward vehicle will decrease, when the intelligent vehicle has emergency braking driving behavior at the next moment. Therefore, to estimate the potential collision risk of driving area, this invention will propose that driving behavior prediction of forward vehicle is introduced into the reconstruction links for safety environment envelope of intelligent vehicle. Based on the predicted results, the longitudinal and lateral distance between the intelligent vehicle and the forward vehicle are modified to realize the reconstruction for safety environment envelope of intelligent vehicle. Modifier formulas (3) are shown as below:

$$[ \begin{matrix}{C}_{x , j}^{′} ( t ) \\ {C}_{y , j}^{′} ( t )\end{matrix} ] = [ \begin{matrix}{ω}_{x} & 0 \\ 0 & {ω}_{y}\end{matrix} ] \cdot [ \begin{matrix}{C}_{x , j} ( t ) \\ {C}_{y , j} ( t )\end{matrix} ] \qquad ( 3 )$$

Where parameter ωₓ is the longitudinal correction factor, and represents the variations in scale of longitudinal distance, the value range of ωₓ is between 0 and 1 on account of the longitudinal prediction result of forward vehicle based on uniform driving behavior or emergency braking driving behavior. Parameter ω_{y} is the lateral correction factor and represents the variations in scale of lateral distance. Considering the lateral relative position of the intelligent vehicle and the forward vehicle, the value range of ω_{y} is between 0 and 1 on account of the lateral prediction result of forward vehicle based on left-turn or right-turn driving behavior when the lateral spacing gets smaller. While lateral distance gets larger, the value of it is greater than 1. To improve the accuracy of envelope reconstruction for secure environment of intelligent vehicle, the probability value of the result predicted by HMM model is applied to determine the value of ωₓ and ω_{y}.

Reconstruction algorithm for the stable control envelope described in the invention is as follows:

Based on the two-degree-of-freedom bicycle model, considering the tire saturation characteristics and road surface error, the invention establishes an autonomous vehicle dynamics model as shown in equation (4):

$$[ \begin{matrix} \\ \end{matrix} ] = [ \begin{matrix}{a}_{11} & {a}_{12} \\ {a}_{21} & {a}_{22}\end{matrix} ] [ \begin{matrix}β \\ γ\end{matrix} ] + [ \begin{matrix}{b}_{1} \\ {b}_{2}\end{matrix} ] {δ}_{f} \\ {a}_{11} = - \frac{2 {k}_{af} {C}_{f} + 2 {k}_{ar} {C}_{r}}{{mv}_{x}} , \\ {a}_{12} = - 1 + \frac{2 {k}_{af} {C}_{f} {l}_{f} + 2 {k}_{ar} {C}_{r} {l}_{r}}{{mv}_{x}^{2}} \\ {a}_{21} = - \frac{- 2 {k}_{af} {C}_{f} {l}_{f} + 2 {k}_{ar} {C}_{r} {l}_{r}}{{I}_{z}} , \\ {a}_{22} = - \frac{2 {k}_{af} {C}_{f} {l}_{f}^{2} + 2 {k}_{ar} {C}_{r} {l}_{r}^{2}}{{mv}_{x}^{2}} \\ {b}_{1} = \frac{2 {k}_{af} {C}_{f}}{{mv}_{x}} , {b}_{2} = \frac{2 {k}_{af} {C}_{f} {l}_{f}}{{I}_{z}} \qquad ( 4 )$$

Where the state variables β and γ are the sideslip angle and yaw rate; δ_{f} is the front wheel steering angle; C_{f} and Cᵣ stand for the cornering stiffness of the front and rear wheels respectively; k_{af} and kₐᵣ stand for the cornering stiffness adjusting coefficient of the front and rear wheels respectively; vₓ is longitudinal velocity; l_{f} and lᵣ are the distances from the center of gravity(CG) to the front and the rear axles respectively, m and I_{z} are the mass of the intelligent vehicle and the moment about the vertical axis, respectively.

Considering the tire saturation characteristics, to ensure the vehicle lateral control stability, the vehicle yaw rate and the sideslip angle must be limited to a certain range, the invention is defined as a stable control envelope. According to the dynamic characteristics of intelligent vehicles, the stable control envelope should be defined as:

$$\begin{matrix}β ( t ) \leq {β}_{max} = {tan}^{- 1} ( 0.02 µg ) & ( 5 ) \\ γ ( t ) \leq {γ}_{max} = \frac{{a}_{y , max}}{{v}_{x}} & ( 6 )\end{matrix}$$

Where μ is road adhesion coefficient; g is the acceleration of gravity; a_{y,max} is maximum lateral acceleration.

Here, the stability control envelope is mainly based on road adhesion coefficient, tire lateral adhesion and other factors, without considering the constraints of the safety environment envelope, that is, the stability control envelope of the yaw rate and the sideslip angle can be contained so long as. However, when environmental envelope constraints are taken into account, the vehicle yaw rate should fill in the requirement of the intelligent vehicle driving in lateral security environment envelope range, generating the reconstruction of the stable control envelope by integrating the spatial and dynamic characteristics. The reconstruction method is as fellows:

According to the results of safety environment envelope reconstruction, the lateral safe distance between intelligent vehicle and forward vehicle is C′_{y,j}(t); the current lateral velocity of the intelligent vehicle is v_{y}; The lateral acceleration is a_{y}; After passing by time Δt, the lateral displacement of the intelligent vehicle is:

l(t)=v_{y}Δt+½a_{y}² (7)

When l(t)<C′_{y,j}(t), the maximum yaw rate is still

$${γ}_{max} = \frac{{a}_{y , max}}{{v}_{x}}$$

at that time.

When l(t)≥C′_{y,j}(t), it is necessary to restrict a_{y} to ensure that the intelligent vehicle and the forward vehicle will not collide laterally after passing by time Δt, where a_{y}(t)={square root over (2(C′_{y,j}(t)−v_{y}Δt)}.

At that time, the maximum yaw rate is

$${γ}_{max} = \frac{\sqrt{2 ( {C}_{y , j}^{i} ( t ) - {v}_{y} Δ t )}}{{v}_{x}} .$$

### ADVANTAGES OF THE INVENTION

Starting from simulating an actual driver's estimation of potential collision risks in the forward driving area, the forward vehicle driving behavior prediction is introduced to the environment perception link of the intelligent vehicle, to estimate the potential collision risk in forward driving area of intelligent vehicles. The safety environment envelope of intelligent vehicle is reconstructed based on the prediction results of forward vehicle driving behavior. The stable control envelope of intelligent vehicle is reconstructed based on the reconstructed safety environment envelope. Reconstructed safe driving envelope of intelligent vehicle combines the spatial and dynamic characteristics, thus improving the safety and stability of intelligent vehicles.

### DESCRIPTION OF THE DRAWINGS

FIG. 1 is the system block diagram of the invention.

FIG. 2 is the lateral spacing changing schematic diagram of the safety environment envelope when a forward vehicle has left-turn driving behavior:

Where, figure (a) shows the current lateral distance between the intelligent vehicle and the forward vehicle, and figure (b) shows the lateral distance between the intelligent vehicle and the forward vehicle when the forward vehicle has left-turn driving behavior.

FIG. 3 is the longitudinal spacing changing schematic diagram of the safety environment envelope when a forward vehicle has emergency braking driving behavior:

Where, figure (a) shows the current longitudinal distance between intelligent the vehicle and the forward vehicle, figure (b) shows the longitudinal distance between the intelligent vehicle and the forward vehicle when the forward vehicle has emergency braking driving behavior.

FIG. 4 is a schematic diagram of intelligent vehicle stability control envelope.

FIG. 5 shows the stable control envelope reconstruction of the intelligent vehicle left-turning.

Where, figure (a) shows the lateral displacement distance of the intelligent vehicle is also constrainted within the lateral safety distance in the safety environment envelope, figure (b) shows the lateral displacement distance of the intelligent vehicle has exceeded the constraint of the lateral safe distance in the safe environment envelope when the forward vehicle has emergency braking driving behavior:

Parameters in the figures: \textcircled{1}: intelligent vehicle; \textcircled{2}: the forward vehicle; C_{x,j}(t): the longitudinal distance between intelligent vehicle and forward vehicle; C′_{x,j}(t): the longitudinal distance reconstructed after considering driving behavior of forward vehicle; C_{y,j}(t): the lateral distance between intelligent vehicle and forward vehicle: C′_{y,j}(t): the lateral distance reconstructed after considering driving behavior of forward vehicle; l(t): lateral displacement of intelligent vehicle at the next moment.

### SPECIFIC IMPLEMENTATIONS

Following is a clear and complete description of the concept and specific working process of the invention with reference to the drawings and examples. Obviously, the described embodiments are only part of the embodiments of the present invention, not all of them. Based on the embodiments of the present invention, other embodiments acquired by skilled personnel in the field without any creative effort belong to the scope of protection of the present invention.

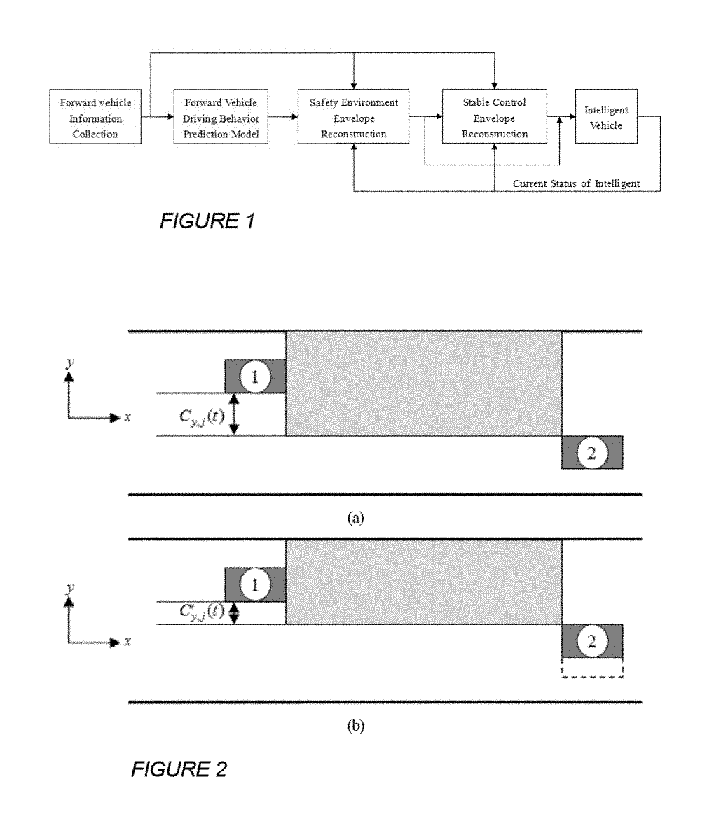

As shown in FIG. 1, a reconstruction method of intelligent vehicle safety driving envelope combining spatial and dynamic characteristics is composed of safety environment envelope reconstruction algorithm and the stable control envelope reconstruction algorithm. First, based on the prediction results of forward vehicle driving behavior; the lateral and longitudinal distances between the intelligent vehicle and the forward vehicle ace corrected and realize the reconstruction of the safety environment envelope of the intelligent vehicle. Then, based on the results of environment envelope reconstruction, and combined with the dynamic characteristics of intelligent vehicles, a stable control envelope reconstruction algorithm is proposed to reconstruct the yaw rate secure area of intelligent vehicles. The potential collision risk in the driving area of intelligent vehicles is estimated by means of the safety driving envelope reconstruction of intelligent vehicles that integrates spatial characteristics and dynamic characteristics, so as to improve the safety and stability of intelligent vehicles.

Reconstruction of safety environment envelope:

The prediction result is considered on left-turning driving behavior of forward vehicle as an example to illustrate the lateral safe distance reconstruction method of the invention:

As shown in FIG. 2, when considering only the current position of forward vehicle \textcircled{2}, the lateral distance C_{y,j}(t) between intelligent vehicle \textcircled{1} and forward vehicle \textcircled{2} is shown as in FIG. 2 (a). When considering that forward vehicle \textcircled{2} has left-turn driving behavior, the lateral distance C′_{y,j}(t) between intelligent vehicle \textcircled{1} and forward vehicle \textcircled{2} is shown as FIG. 2 (b). Comparing FIG. 2 (a) and FIG. 2 (b), we can see that the lateral spacing between the intelligent vehicle \textcircled{1} and the forward vehicle \textcircled{2} gets smaller. Based on the prediction result, lateral safety distance is reconstructed to achieve new lateral secure model C′_{y,j}(t)=ω_{y}C_{y,j}(t), where ω_{y} is lateral correction factor; represents the variations in scale of lateral distance, and its value depend on the predicted maximum likelihood probability of the left-turning driving behavior of the forward vehicle driving behavior prediction model. It can be seen that when considering the left-turn driving behavior of vehicles in front. intelligent vehicles predict the left-turn driving behavior of forward vehicle, and reduce the risk of lateral collision by reconstructing the lateral safe distance.

The prediction result is considered on emergency braking driving behavior of forward vehicle as an example to illustrate the longitudinal safe distance reconstruction method of the invention:

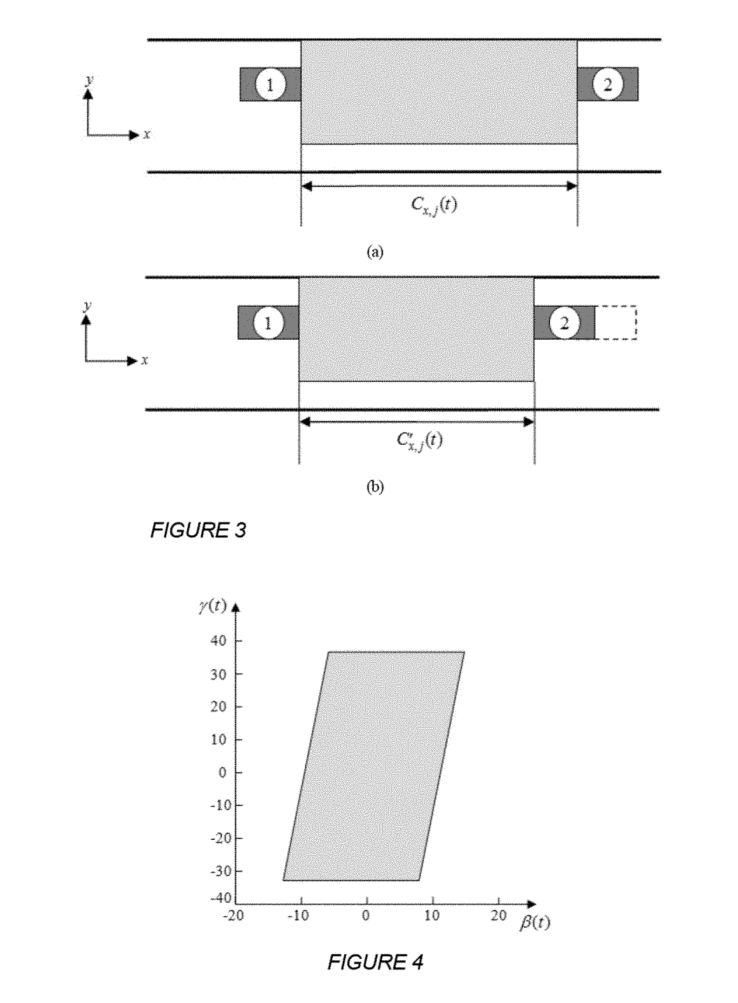

As shown in FIG. 3, when considering only the current position of forward vehicle \textcircled{2}, the longitudinal distance C_{x,j}(t) between intelligent vehicle \textcircled{1} and forward vehicle \textcircled{2} is shown as in FIG. 3 (a). When considering that forward vehicle \textcircled{2} has emergency braking driving behavior, the longitudinal distance C′_{x,j}(t) between intelligent vehicle \textcircled{1} and forward vehicle \textcircled{2} is shown as FIG. 3 (b). Comparing FIG. 3 (a) and FIG. 3 (b), we can see that the longitudinal spacing between the intelligent vehicle \textcircled{1} and the forward vehicle \textcircled{2} gets smaller. Based on the prediction result, longitudinal safe distance is reconstructed to achieve new longitudinal safe model C′_{x,j}(t)=ωₓC_{x,j}(t), where ωₓ is longitudinal correction factor, represents the variations in scale of longitudinal distance, and its value depend on the predicted maximum likelihood probability of the emergency braking driving behavior of the forward vehicle driving behavior prediction model. It can be seen that when considering the emergency braking driving behavior of forward vehicle, intelligent vehicle predict the emergency braking driving behavior of forward vehicle, and reduce the risk of longitudinal collision by reconstructing the longitudinal safe distance.

Reconstruction of stable control envelope:

Considering the tire saturation characteristics, to ensure the vehicle lateral control stability, the vehicle sideslip angle and yaw rate must be limited to a certain range, the invention is defined as a stable control envelope. According to the dynamic characteristics of intelligent vehicles, the stable control envelope should be defined as:

$$β ( t ) \leq {β}_{max} = {tan}^{- 1} ( 0.02 µg )$$

$$γ ( t ) \leq {γ}_{max} = \frac{{a}_{y , max}}{{v}_{x}}$$

The stable control envelope is shown in FIG. 4.

The stability control envelope is mainly based on road adhesion coefficient, tire lateral adhesion and other factors, without considering the constraints of the safety environment envelope, that is, the sideslip angle and yaw rate can satisfy the constraints as long as they are within the stable control envelope. However, when safety environment envelope constraints are taken into account, the vehicle yaw rate should meet the the constraints of safely environment envelope of intelligent vehicle. Therefore, it is necessary to reconstruct the stable control envelope by combining the spatial and dynamic characteristics. The reconstruction method is as follows:

Taking the left-turning driving behavior of forward vehicle as an example below, the yaw rate reconstruction of the invention is explained:

According to the results of safety environment envelope reconstruction, the lateral safe distance between intelligent vehicle and forward vehicle is C′_{y,j}(t), the current lateral velocity of the intelligent vehicle is v_{y}, and the lateral acceleration is a_{y}. After passing by time Δt, the lateral displacement of the intelligent vehicle is:

l(t)=v_{y}Δt+½a_{y}²

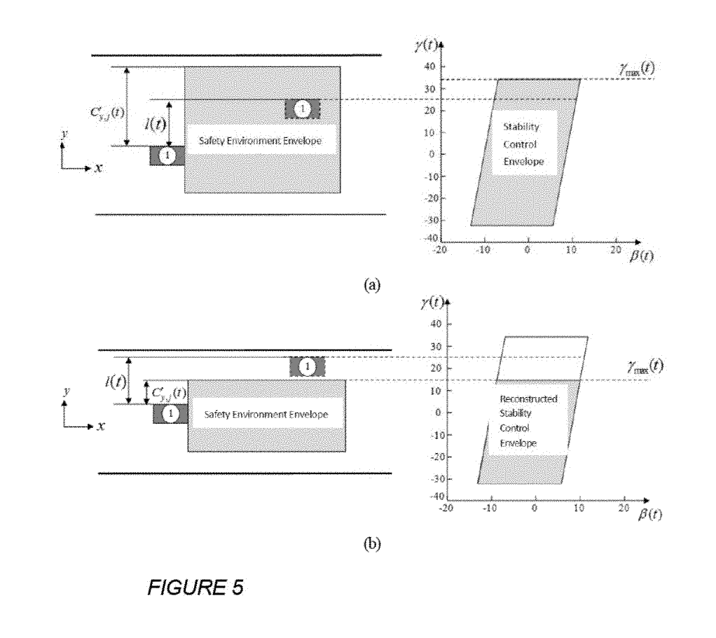

As shown in FIG. 5(a), when l(t)<C′_{y,j}(t), the lateral displacement distance of the intelligent vehicle is also constrainted within the lateral safety distance in the safety environment envelope, so, the maximum yaw rate is still

$${γ}_{max} = \frac{{a}_{y , max}}{{v}_{x}}$$

at this point.

As shown in FIG. 5(b), when l(t)≥C′_{y,j}(t), at this time, the yaw rate is still within the range of the initial stable control envelope, but at this time, the lateral displacement distance of the intelligent vehicle has exceeded the constraint of the lateral safe distance in the safe environment envelope, so it is necessary to limit the yaw rate and reconstruct the stable control envelope. At this time, it is necessary to restrict a_{y} to ensure that the intelligent vehicle and the forward vehicle will not collide laterally after passing time Δt, where a_{y}(t)={square root over (2(C′_{y,j}^{l}(t)−v_{y}Δt))}. The maximum yaw rate is

$${γ}_{max} = \frac{\sqrt{2 ( {C}_{y , j}^{i} ( t ) - {v}_{y} Δ t )}}{{v}_{x}}$$

at this point.

The series of detailed explanations listed above are only specific explanations of the feasible embodiments of the invention, and they are not intended to limit the scope of protection of the invention. Any equivalent implementation or modification without departing from the spirit of the present invention shall be included in the scope of protection of the present invention.

1. A reconstruction method of intelligent vehicle safety driving envelope combining spatial and dynamic characteristics, comprising safety environment envelope reconstruction algorithm and the stable control envelope reconstruction algorithm, based on the prediction results of forward vehicle driving behavior from the driving behavior prediction model, the safety environment envelope reconstruction algorithm is responsible for modifying the lateral and longitudinal safe distances between the intelligent vehicle and forward vehicle, to realize the pre-estimation to the potential collision risk in the driving area of the intelligent vehicle, and improves the safety of the intelligent vehicle; to improve the stability of the intelligent vehicle, stable control envelope reconstruction algorithm is responsible for the reconstruction of stable region of the yaw rate based on the results of the environment envelope reconstruction and the dynamic characteristics of the intelligent vehicle.

2. According to the reconstruction method of intelligent vehicle safety driving envelope combining spatial and dynamic characteristics described in claim 1, the invention is characterized in that the intelligent vehicles safe environment envelope reconstruction algorithm is as follows:
the secure driving area in front of the intelligent vehicle is determined based on the lateral and longitudinal distance between the forward vehicle and the intelligent vehicle, that is, the safety environment envelope described in this invention, according to the sensor and dynamic model, the relative position information of the intelligent vehicle and the forward vehicle is established, as shown below:
$$[ \begin{matrix}Δ {p}_{x , j} ( t ) \\ Δ {p}_{y , j} ( t )\end{matrix} ] = [ \begin{matrix}cos ( - {e}_{ψ} ( t ) ) & - sin ( - {e}_{ψ} ( t ) ) \\ sin ( - {e}_{ψ} ( t ) ) & cos ( - {e}_{ψ} ( t ) )\end{matrix} ] [ \begin{matrix}{p}_{x , j} ( t ) - {p}_{x , sub} ( t ) \\ {p}_{y , j} ( t ) - {p}_{y , sub} ( t )\end{matrix} ]$$
where p_{x,j}(t) is the longitudinal coordinates of the jth forward vehicle; p_{x,sub}(t) is the longitudinal coordinates of the intelligent vehicle; e_{Ψ}(t) is the position error between vehicle and road surface; p_{y,j}(t) is the lateral coordinates of the jth forward vehicle; p_{y,sub}(t) is the lateral coordinates of the intelligent vehicle; Δp_{x,j}(t) is the longitudinal relative distance between the smart vehicle and the jth forward vehicle; Δp_{y,j}(t) is the lateral relative distance between the smart vehicle and the jth forward vehicle;
the distance between intelligent vehicle and forward vehicle can be obtained by transformation, as shown below:
$$[ \begin{matrix}{C}_{x , j} ( t ) \\ {C}_{y , j} ( t )\end{matrix} ] = [ \begin{matrix}Δ {p}_{x , j} ( t ) \\ Δ {p}_{y , j} ( t )\end{matrix} ] - [ \begin{matrix}sgn ( Δ {p}_{x , j} ( t ) ) \cdot {L}_{v} \\ sgn ( Δ {p}_{y , j} ( t ) ) {W}_{v}\end{matrix} ]$$
Where: Lᵥ is the length of the forward vehicle; Wᵥ is the width of the forward vehicle; C_{x,j}(t) is the longitudinal distance between intelligent vehicle and forward vehicle; C_{y,j}(t) is the lateral distance between intelligent vehicle and forward vehicle;
the invention will propose that driving behavior prediction of forward vehicle is introduced into the reconstruction links for safety environment envelope of intelligent vehicle; based on the predicted results, the longitudinal and lateral distance between the intelligent vehicle and the forward vehicle are modified to realize the reconstruction for safety environment envelope of intelligent vehicle, modifier formulas are shown as below:
$$[ \begin{matrix}{C}_{x , j}^{′} ( t ) \\ {C}_{y , j}^{′} ( t )\end{matrix} ] = [ \begin{matrix}{ω}_{x} & 0 \\ 0 & {ω}_{y}\end{matrix} ] \cdot [ \begin{matrix}{C}_{x , j} ( t ) \\ {C}_{y , j} ( t )\end{matrix} ]$$
where parameter ωₓ is the longitudinal correction factor, and represents the variations in scale of longitudinal distance; parameter ω_{y} is the lateral correction factor and represents the variations in scale of lateral distance; C_{x,j}(t) is the longitudinal distance between intelligent vehicle and forward vehicle, C′_{x,j}(t) is the longitudinal distance reconstructed after considering driving behavior of forward vehicle; C_{y,j}(t) is the lateral distance between intelligent vehicle and forward vehicle, C′_{y,j}(t) is the lateral distance reconstructed after considering driving behavior of forward vehicle.

3. According to the reconstruction method of intelligent vehicle safety driving envelope combining spatial and dynamic characteristics described in claim 2, the invention is characterized in that the value range of ωₓ is between 0 and 1; the value range of ω_{y} is between 0 and 1 when the lateral spacing gets smaller; while the lateral distance gets larger; the value range of ω_{y} is greater than 1.

4. According to the reconstruction method of intelligent vehicle safety driving envelope combining spatial and dynamic characteristics described in claim 2, the invention is characterized in that the forward vehicle driving behavior prediction is based on hidden Markov model (HMM).

5. According to the reconstruction method of intelligent vehicle safety driving envelope combining spatial and dynamic characteristics described in claim 1, the invention is characterized in that the stable control envelope reconstruction algorithm of intelligent vehicles is as follows:
based on the two-degree-of-freedom bicycle model, considering the tire saturation characteristics and road surface error; the invention establishes an autonomous vehicle dynamics model, as shown below:
$$[ \begin{matrix} \\ \end{matrix} ] = [ \begin{matrix}{a}_{11} & {a}_{12} \\ {a}_{21} & {a}_{22}\end{matrix} ] [ \begin{matrix}β \\ γ\end{matrix} ] + [ \begin{matrix}{b}_{1} \\ {b}_{2}\end{matrix} ] {δ}_{f}$$
$$where \text{:}$$
$${a}_{11} = - \frac{2 {k}_{af} {C}_{f} + 2 {k}_{ar} {C}_{r}}{{mv}_{x}} , \\ {a}_{12} = - 1 + \frac{2 {k}_{af} {C}_{f} {l}_{f} + 2 {k}_{ar} {C}_{r} {l}_{r}}{{mv}_{x}^{2}} , \\ {a}_{21} = - \frac{- 2 {k}_{af} {C}_{f} {l}_{f} + 2 {k}_{ar} {C}_{r} {l}_{r}}{{I}_{z}} , \\ {a}_{22} = - \frac{2 {k}_{af} {C}_{f} {l}_{f}^{2} + 2 {k}_{ar} {C}_{r} {l}_{r}^{2}}{{mv}_{x}^{2}} , \\ {b}_{1} = \frac{2 {k}_{af} {C}_{f}}{{mv}_{x}} , {b}_{2} = \frac{2 {k}_{af} {C}_{f} {l}_{f}}{{I}_{z}}$$
the state variables β and γ are the sideslip angle and yaw rate; δ_{f} is the front wheel steering angle; C_{f} and Cᵣ stand for the comering stiffness of the front and rear wheels respectively; k_{af} and kₐᵣ stand for the comering stiffness adjusting coefficient of the front and rear wheels respectively; vₓ is longitudinal velocity; l_{f} and lᵣ are the distances from the center of gravity(CG) to the front and the rear axles respectively; m and I_{z} are the mass of the intelligent vehicle and the moment about the vertical axis, respectively;
according to the dynamic characteristics of intelligent vehicles, the stable control envelope should be defined as:
$$β ( t ) \leq {β}_{max} = {tan}^{- 1} ( 0.02 µg )$$
$$γ ( t ) \leq {γ}_{max} = \frac{{a}_{y , max}}{{v}_{x}}$$
where μ is road adhesion coefficient; g is the acceleration of gravity; a_{y,max} is maximum lateral acceleration;
considering the constraints of the safety environment envelope, the stability control envelope is reconstructed by combining the spatial and dynamic characteristics.

6. According to the reconstruction method of intelligent vehicle safety driving envelope combining spatial and dynamic characteristics described in claim 5, the invention is characterized in that the stable control envelope reconstruction algorithm of intelligent vehicles is as follows:
according to the results of safely environment envelope reconstruction, the lateral safe distance between intelligent vehicle and forward vehicle is C′_{y,j}(t); the current lateral velocity of the intelligent vehicle is v_{y}; the lateral acceleration is a_{y}; after passing the time Δt, the lateral displacement of the intelligent vehicle is:
l(t)=v_{y}Δt+½a_{y}²
when l(t)<C′_{y,j}(t), the maximum yaw rate is still
$${γ}_{max} = \frac{{a}_{y , max}}{{v}_{x}}$$
at that time;
when l(t)≥C′_{y,j}(t), it is necessary to restrict a_{y} to ensure that the intelligent vehicle and the forward vehicle will not collide laterally after passing by time Δt, where a_{y}(t)={square root over (2(C′_{y,j}(t)−v_{y}Δt))};
at that time, the maximum yaw rate is
$${γ}_{max} = \frac{\sqrt{2 ( {C}_{y , j}^{i} ( t ) - {v}_{y} Δ t )}}{{v}_{x}} .$$
